(19) United States
(12) Patent Application Publication
(10) Pub. No.: US 2008/0004947 A1
(43) Pub. Date: Jan. 3, 2008

(54) ONLINE KEYWORD BUYING, ADVERTISEMENT AND MARKETING

(75) Inventors: Ashvin J. Mathew, Kirkland, WA (US); Brendan A. O'Meara, Bellevue, WA (US); Nicolae Surpatanu, Duvall, WA (US); Rajat Taneja, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: MICROSOFT CORPORATION, Redmond, WA (US)

(21) Appl. No.: 11/427,030

(22) Filed: Jun. 28, 2006

(51) Int. Cl. G06Q 30/00

(52) U.S. Cl. 705/14

(57) ABSTRACT

A computer-implemented method of providing keyword purchasing assistance to a business for online marketing or advertising includes the step of identifying product or service offerings, of the business, to be targeted with the online marketing or advertising. Once the offerings to be targeted are identified, business data corresponding to the identified offerings is obtained. A statistical analysis is performed on the business data to determine keywords. Then, based upon those keywords determined from the statistical analysis, keyword suggestions are provided.

### BACKGROUND

Advertising and marketing products or services over the internet has become very commonplace. Internet market places, comparison shopping sites, algorithmic searches and contextual paid placements (PPC/CPC) are changing the dynamics of how small businesses sell and market their products and services. However, the processes that small businesses have to follow currently to become part of a market place, a comparison shopping site or search listing are very manual, time consuming and ad hoc. There is a lot of instinct and gut feel involved in the process, and very little quantitative business data guiding judgment around investments. In addition, each of these processes is duplicative and replete with friction.

To advertise or market over the internet, it is common for a business to purchase keywords from a search engine provider. Then, when an internet user initiates a search using the search engine and the purchased keywords, one of several things can happen to market the business. For example, when the purchased keywords are used with the search engine to search, an advertisement of the business can be displayed to the user. The placement of the advertisement can be a function of how much the business paid for the keywords relative to other purchasers of the same keywords, for example. In other cases, in response to a search using the purchased keywords, a link to the business can be provided in a ranked list of links. As with advertisement placement, where in the ranked list the link to the business occurs can be a function of how much the business paid for the keywords relative to other purchasers of the same keywords. As a result, purchasing keywords can be expensive due to the competition from other businesses.

Determining which keywords to purchase is therefore an important decision for businesses. As mentioned, however, the purchasing of keywords for online marketing and advertising is currently often a guessing game based more on hunch and intuition than analytics. To date, most analytics that have been proposed to aid in this process have been more related to click through tracking than to other business metrics. In click through tracking, statistics relating to the number of times, or percentage of the time, that search engine users click on displayed advertisements or links are tracked. While click through tracking can be an important metric in determining which keywords for a business to purchase, as a sole metric it leaves room for improvement.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

Disclosed embodiments aid in making informed decisions in the process of buying keywords for online marketing and advertising. Taking the guessing game out of the process allows the purchasing decisions to be made more automatically based on certain criteria, instead of being done based more on hunch and intuition than analytics. Disclosed embodiments utilize statistical analysis of business data to determine keywords for particular product or service offerings. The business data includes data related to the offerings, for example such as product or service titles, product or service descriptions, product Universal Product Codes (UPCs), product or service brand names, etc. Other business data types can be used instead of, or in addition to, one or more of these business data types. An example of a statistical analysis includes identification of words with the highest occurrence frequencies in the business data. Based on the keywords identified in the statistical analysis, keyword suggestions are provided.

In some embodiments, a linguistic analysis is performed on the keywords determined by the statistical analysis. The linguistic analysis identifies one or more keyword phrases. Keyword phrases are then provided as the keyword suggestions.

### BRIEF DESCRIPTION OF THE DRAWINGS

FIG. 1-1 is a block diagram illustrating an online advertising campaign system embodiment.

FIG. 1-2 is an example chart illustrating a search tail.

FIG. 1-3 is a representation of a graphical user interface of ranked links.

FIG. 2 is a flow diagram illustrating a first method embodiment.

FIG. 3 is a flow diagram illustrating a second method embodiment.

FIG. 4-1 is a flow diagram illustrating additional steps of a method embodiment.

FIG. 4-2 is a flow diagram illustrating additional steps of a method embodiment.

FIGS. 5-1 through 5-7 illustrate graphical user interfaces which can be generated to aid in ad campaign development in accordance with some embodiments.

FIG. 6 is a block diagram illustrating a general computing environment configured to implement disclosed embodiments.

### DETAILED DESCRIPTION

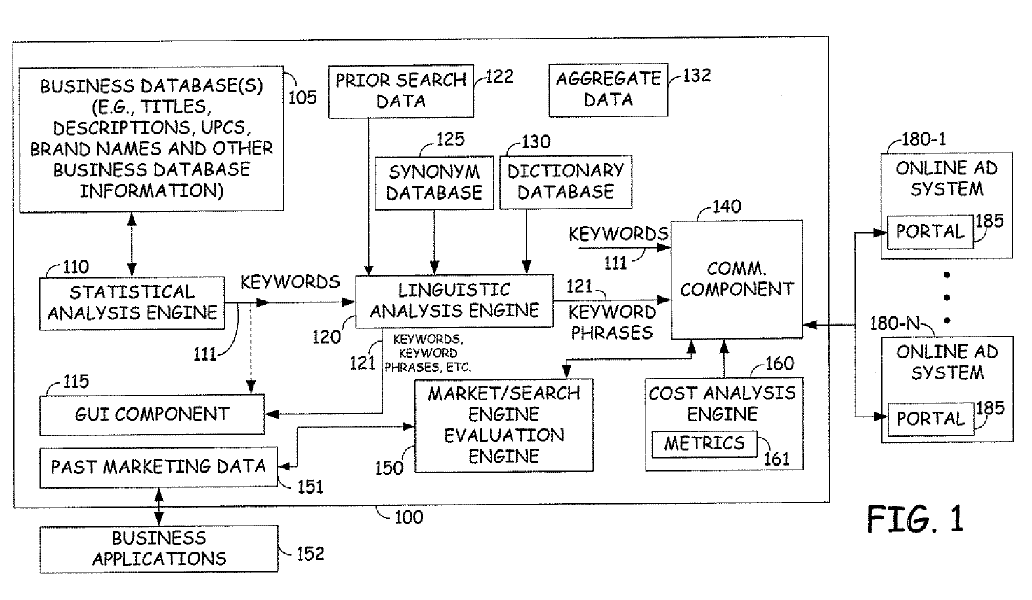

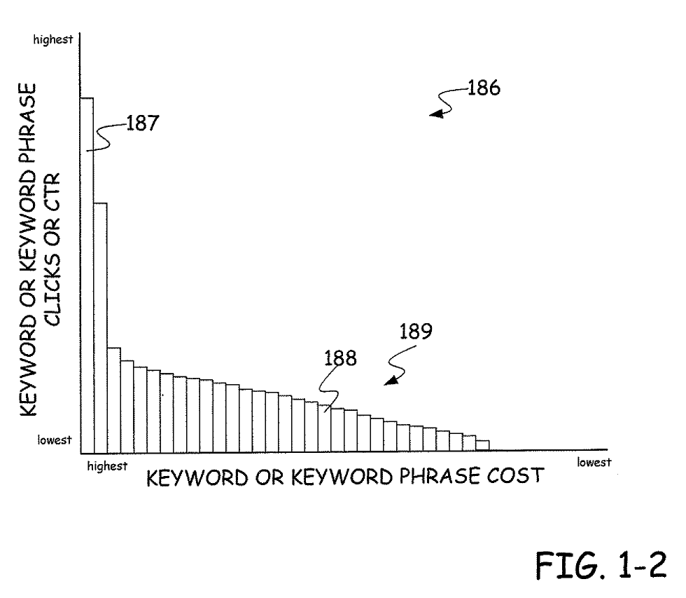

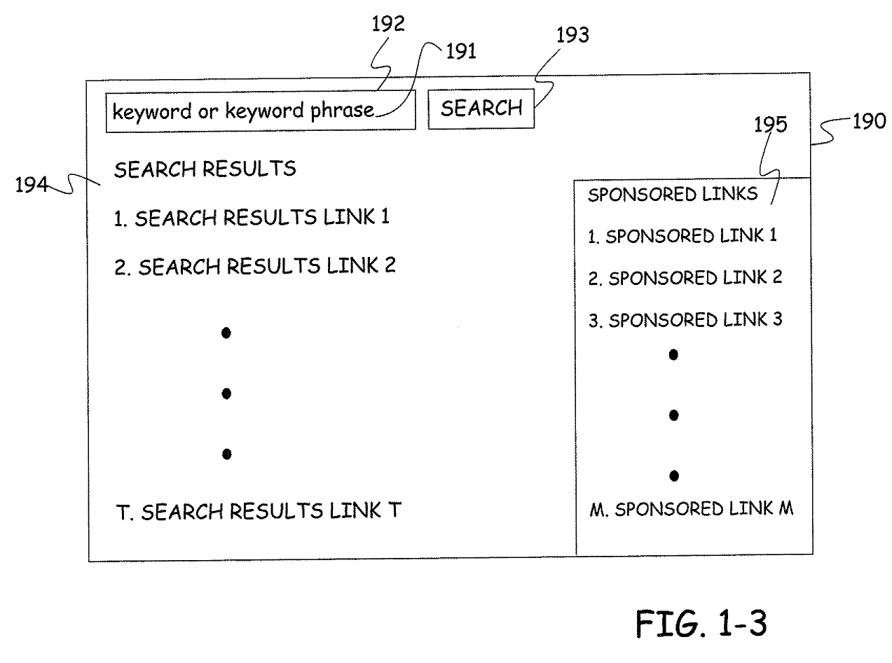

FIG. 1-1 is a block diagram illustrating an online advertising campaign system 100 in accordance with example embodiments. System 100 assists users or businesses in determining which keywords to purchase for their online marketing or advertising campaigns. System 100 and the disclosed methods which can be implemented with such a system utilize statistical, linguistic and other analysis to propose possible keywords and keyword phrases. Disclosed embodiments are explained at times in the context of an accounting application, for example like Microsoft® Small Business Accounting. The disclosed embodiments are not limited to either this specific accounting application, or to accounting applications in general. Instead, disclosed embodiments can be used in conjunction with various business applications, for example such as Enterprise Resource Planning (ERP) systems, which have business data relating to product or service offerings of a business. The disclosed embodiments can also be used separately from any business application, relying only on access to business data.

As shown in FIG. 1-1, system 100 includes one or more business databases 105 (collectively referred to as a business database) containing business data relating or corresponding to product or service offerings of the business. An offering is defined as any item or service that is offered by the business. Using various methods, for example the use of business rules, target offerings are determined for a business. Examples of business rules include, for example, rules which select most profitable items in inventory of the business, rules which select items based on inventory levels, rules that select items as a function of the return on investment (ROI) on past sales and campaigns, rules that select items based on seasonality or perishability of inventory, etc. Disclosed embodiments are not limited to any particular method of determining target offerings, and business rules need not be used in all embodiments to determine target offerings.

Once the target offerings have been determined, these target offering are then analyzed by system 100 to determine the keywords to be used. In business applications, there is considerable data available on offerings. Examples of the types of data that can be included in database 105 include Titles, Descriptions, UPCS, Brands, Manufacturer name, stock keeping unit (SKU), etc. These or other data types can be used to determine effective keywords. This data on the various offerings contained in the business application can be mined by statistical analysis to determine frequency of words.

System 100 includes a statistical analysis engine 110 which is configured or programmed to perform the statistical analysis on the business data to determine keywords 111. For example, the statistical analysis engine 110 can be configured to determine keywords 111 by identifying words in database(s) 105 having highest occurrence frequencies in the business data. In some embodiments, the keywords 111 identified by engine 110 can be provided to a graphical user interface (GUI) component 115 for displaying to a user as keyword suggestions. The user can then approve, modify or reject the keyword suggestions.

In exemplary embodiments, while the keyword suggestions are based upon the keywords identified by the statistical analysis engine, the actual keyword suggestions are generated in the form of keywords or keyword phrases by a linguistic analysis engine 120. A keyword phrase is defined here as a combination of at least two keywords. Linguistic analysis engine is configured or programmed to perform linguistic analysis on the keywords 111 determined by the statistical analysis engine 110 in order to identify one or more keywords or keyword phrases 121. The linguistic analysis engine utilizes past searching behavior, e.g., in the form of prior search data 122 (e.g., prior search logs) from search engines, in the process of identifying the alternate keywords or keyword phrases. The GUI component 115 can then display the keyword phrases as the keyword suggestions.

In various embodiments, linguistic analysis engine 120 uses various types of linguistic analysis in the identification of keyword phrases 121. For example, in some embodiments, engine 120 eliminates keywords 111 which are determined to have a low likelihood of being relevant to offerings to be targeted. The relevance can be determined using conventional linguistic techniques and prior search data 122 indicative of previous search behavior.

Also, in some embodiments, system 100 includes a thesaurus or synonym database 125 and/or a dictionary database 130 which are used by the linguistic analysis engine 120. In these embodiments, the linguistics engine 120 can be configured to use one or both of the databases 125 and 130 to identify other words which are similar to the keywords determined by the statistical analysis, but more commonly used by consumers. For example, for the keyword 111 of “shoes”, using database 125 and/or database 130, linguistic analysis engine 120 might offer keywords or keyword phrases 121 such as “slippers”, “boots”, “hiking boots”, “running shoes”, etc. Determination of how likely these similar keywords or keyword phrases are used by consumers can be determined using prior search data 122. These other words can then be provided in keyword phrases 121. As a more specific example, if the original keyword 111 was “shoes”, and linguistic analysis engine identifies “boots” and “sandals” as alternative keywords, an analysis of consumer use of these terms is conducted. It based on prior search data 122 or on other criteria, linguistic analysis engine 120 determines that consumers are searching on “boots” more often than on “sandals”, the keyword “boots” will be pushed up in the rankings of recommended keywords relative to the keyword “sandals”.

Linguistic analysis engine 120 is also configured, in some embodiments, to apply a variety of linguistic rules in determining keywords or keyword phrases 121. For example, engine 120 can apply rules based on parts of speech of keywords or keyword phrases, collocation rules for multiple words of a keyword phrase, occurrence frequency statistics for keywords or keyword phrases, etc.

In some embodiments, system 100 includes an advertising portal communication component 140 which is used to communicate with advertising portals 185 of online advertising systems 180. These online advertising systems offer the search engines which consumers use to conduct online searches. In FIG. 1-1, N different advertising system (180-1 through 180-N) are represented. The communication component 140 sends, in some embodiments, the keyword phrases 121 (or alternately the keywords 111 in some embodiments) to at least one advertising portal 185 to initiate a process of purchasing the keyword phrase from the corresponding online advertising system 180.

In some embodiments, system 100 includes a cost analysis engine 160 which uses communication component 140 to communicate with multiple online advertising systems 180 in order to determine costs keyword phrases at each system. Cost analysis engine 160 can then use market share/search share metrics 161 to identify one or more of the most effective online marketing engines (online advertisement systems 180) for the keyword phrase. The advertising campaign can then target the identified marketing engines which are most effective. The targeted marketing engine suggestions, as well as keyword phrase suggestions, are then provided to a user via GUI component 115, and/or sent to the relevant online systems 180 to initiate purchase of keyword phrases.

In some embodiments, system 100 includes a evaluation engine 150 which uses communication component 140 to query bid costs from one or more online advertisement systems 180. Engine 150 then analyzes bid cost and position within listing or rank for each of multiple candidate keyword phrases to determine optimal bid-to-position tradeoffs. The optimal bid-to-position tradeoffs are then compared for each candidate keyword phrase to identify least expensive keywords for a particular position within listing or rank. These aspects of evaluation engine 150 are described further below in accordance with example embodiments.

System 100 can also make keyword phrase suggestions based on previous search data, advertising engine data, and/or other aggregate data 132. This data can be used to expand the range of keywords. Examples of other such aggregate data include data indicative of: (1) people who searched for X (product or service) also searched for Y; (2) the number of searches performed for given keywords or keyword phrases; (3) the number of listings for a given keyword or keyword phrase. Other search data can be used as well by linguistic analysis engine 120 or by other components of system 100 to both expand the keywords and to determine the most effective keywords.

In some embodiments, system 100 is configured to utilize the concept of a search tail to identify keyword phrases that might be cheaper than broader terms, yet just as likely to be searched on. For example, evaluation engine 150 and/or cost analysis engine 160 can be configured to provide such functionality. Generally, broad keywords such as “lawyer” or “bicycle” tend to cost more than narrower keyword phrases. Yet, consumers searching for a specific item to buy tend to use more specific keyword combinations or phrases. For example, someone involved in an automobile accident may be more likely to search using the keyword phrase “auto accident lawyer” than they are to search using the broader keyword “lawyer”. Since the narrower keyword phrase is also frequently less expensive, system 100 capitalizes on this fact and targets the search tail of a search power curve.

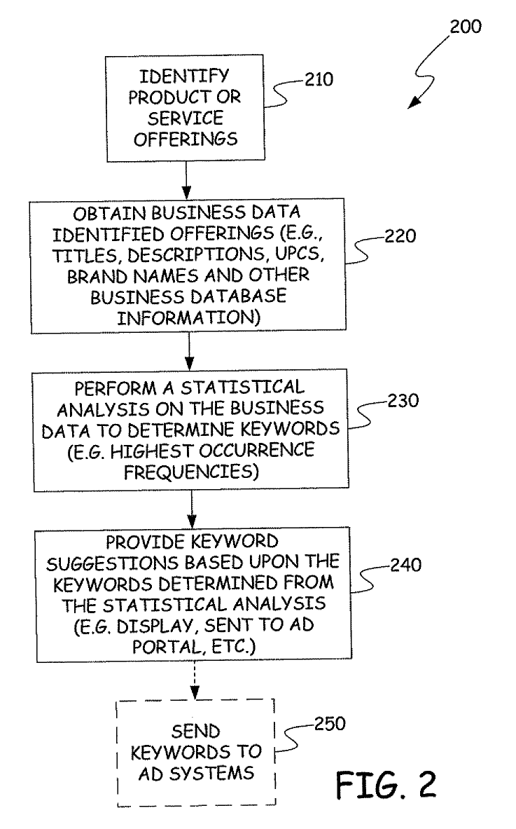

Referring to FIG. 1-2, shown is an example of a chart which illustrates on one axis the clicks or the click through rates (CTRs) for a number of keywords or keyword phrases for one example search engine provider. On the second axis, the chart illustrates an example of the cost for the same keywords or keyword phrases as charged by the example search engine provider. As can be seen, a keyword represented at 187 has the highest number of clicks or CTR, but also costs significantly more than other keywords or keyword phrases. In contrast, another keyword or keyword phrase represented at 188 has a lower number of clicks or CTR, but also has a significantly lower cost. Keywords or keyword phrases such as shown at 188 are generally know as being part of the search tail 189.

In some disclosed embodiments, system 100 in configured, for example via configuration of either of engines 150 and 160, to analyze the search tail 189 for words related to an identified target offering. The words can be synonyms related to the target offering, multiple word phrases related to the target offering, etc. System 100 identifies keywords or keyword phrases which have a reduction in cost relative to most expensive keywords (e.g., keyword corresponding to 187) which outpaces the reduction in clicks or CTR relative to the most expensive keywords. For example, consider the case where a target offering is a type of shoes. Using a power curve or chart 186, or a function describing the power curve or chart, system 100 might identify that keyword “shoes” receives twice as many clicks in response to search engine queries as the keyword “boots”, but that the cost of purchasing the keyword “shoes” is four times higher than the cost of purchasing the keyword “boots”. In another example, the cost of purchasing the keyword “shoes” might be eight times higher than the cost of purchasing keyword phrases such as “running shoes” or “hiking boots”, with these phrases or keywords having been identified or generated by linguistic analysis engine 120 in response to the keywords generated by statistical analysis engine 110.

System 100 analyzes the power curve 186, and particularly the search tail 189, to identify these more cost effective words or phrases, and recommends them to the user. With the reduction in cost of purchasing some keywords or keyword phrases, additional keywords or keyword phrases can be purchased for the same advertising budget as would have been required to purchase the more expensive keywords 111. In addition to reducing the cost of purchasing keywords, as has been noted the use of the less expensive keyword phrases is often in accordance with users actual search habits—e.g., searching using phrases instead of individual keywords. This can in turn result in a more effective search, for much less cost. Further, in some instances, users searching under more specific keyword phrases (e.g., “Trek mountain bikes”) are more likely to ultimately purchase items than are those who conduct more general searches (e.g., “bicycle”). This further aids in the marketing optimization process.

As a more particular example of one embodiment of the process of identifying keywords, consider that for a targeted offering such as bicycles, the corpus of business data 105 is used to identify keywords via a statistical analysis. For sake of illustration, assume that the targeted offering was based on the largest numbers of inventory items, for example 100 bicycles, and “trail bikes” and “mountain bikes” were the most common classifying words used to describe this portion of the inventory. The statistical analysis might find that the terms “bicycle”, “mountain” and “trail” would be the most common (in terms of frequency) terms.

Using these keyword candidates 111 based on frequency in the corpus, the linguistic analysis on those terms is used to identify terms that better describe the inventory. This linguistic analysis can be conducted using database 125 and/or database 130, as well as prior search data 122 indicative of consumer search behavior. For this example, where the statistical analysis might have ended up with the terms “bicycle”, “mountain” and “trail”, the logical combinations based on linguistic analysis might be “trail bicycles” and “mountain bicycles”, as they better describe the bicycle. As can be determined using the above described techniques, engines such as cost analysis engine 160 can identify (for example using the search keyword power curve or chart 186 to target tail 189) whether these keyword phrases are less expensive than the broader, but sometimes less (or no more) effective keywords such as “bicycle”. Some disclosed embodiments take advantage of this inversion between the most expensive words, and the actual search phrases used by searchers. Even in the broader keywords are more effective, system 100 takes advantage of the fact that the pricing for the broadest keywords is often disproportionately higher than the pricing of keywords or keyword phrases in the search tail, relative to the proportional effectiveness of the keywords.

Referring now to FIG. 1-3, shown is a representation of a GUI 190 of a search engine. As shown in FIG. 1-3, a keyword or keyword phrase 191 is input by a user into a text input box 192. After search button 193 is selected or clicked on, a ranked list 194 of search results are returned in a search pane. Also returned is a ranked list 195 of sponsored links in another search pane. The sponsored links correspond to websites of sellers who have purchased keywords for marketing their offerings. Other sponsored links areas can also be included on the GUI 190, for example, above ranked list 194 of search results.

Generally speaking, the more an online merchant pays for particular keywords or keyword phrases, the higher the merchants link will appear in the ranked list of sponsored links. However, it has been found that users of search engines often don't click on the links at the top of the list, but rather they frequently click on links more toward the center of the list 195. Therefore, in many instances, the premium keyword prices paid in order to be at the top of the ranked list 195 are not justified.

As discussed above, evaluation engine 150 queries bid costs from one or more online advertisement systems 180. Engine 150 then analyzes bid cost and position within listing or rank for each of multiple candidate keyword phrases to determine optimal bid-to-position tradeoffs. The optimal bid-to-position tradeoffs are then compared for each candidate keyword phrase to identify least expensive keywords for a particular position within listing or rank. In identifying or determining bid optimization, the merchant's historical online marketing or sales data 151 is used to determine if there has been, for this particular user, a proportional increase in clicks or CTR for increases in bids (placing the merchant's sponsored link higher in list 195). For example, the past marketing data, which can be obtained from business accounting systems or other business applications or systems 152, can identify whether the twenty-five percent increase in keyword costs purchased in a past month resulted in a proportionately increased number of clicks or CTR. Engine 150 can then optimize the keyword bid process. If proportionally higher CTRs or higher numbers of clicks are achieved through a higher bid (cost) for keywords or keyword phrases, then engine 150 can recommend such higher bids as recommended course of action. If not, then engine 150 recommends, in some embodiments, lower bids which would secure placement of the merchant's link in list 195, but not at the top of the list. For example, if engine 150 determines that the difference in costs (costs provided by online ad systems 180) between the first bid for the keyword or keyword phrase and the fifth bid for the same keyword or keyword phrase is sixty percent lower, but the click through between the two positions is less than sixty percent, engine 150 can select the fifth bid position of sponsored links to recommend to the merchant.

Referring now to FIG. 2, shown is a flow diagram illustrating an embodiment of a method 200 of providing keyword purchasing assistance to a business for online marketing or advertising. The method includes step 210 of identifying product or service offerings to be targeted with the online marketing or advertising campaign. As noted above, in disclosed embodiments, any method of identifying the targeted offerings can be used. Then, at step 220, the method includes obtaining business data corresponding to the identified offerings. Examples of business data were discussed above, but disclosed embodiments are not limited to any particular type of business data. After obtaining the business data, the method includes step 230 of performing a statistical analysis on the business data to determine keywords. As noted above, one example type of statistical analysis identifies keyword candidate terms as a function of occurrence frequencies of the terms in the business data. Then, at step 240, the method includes providing keyword suggestions based upon the keywords determined from the statistical analysis. Providing the keyword suggestions includes, in some embodiments, displaying the keyword suggestions to a user for acceptance, modification or rejection. The method can then optionally include step 250 of sending the keywords to an advertising system to initiate purchase of the keywords.

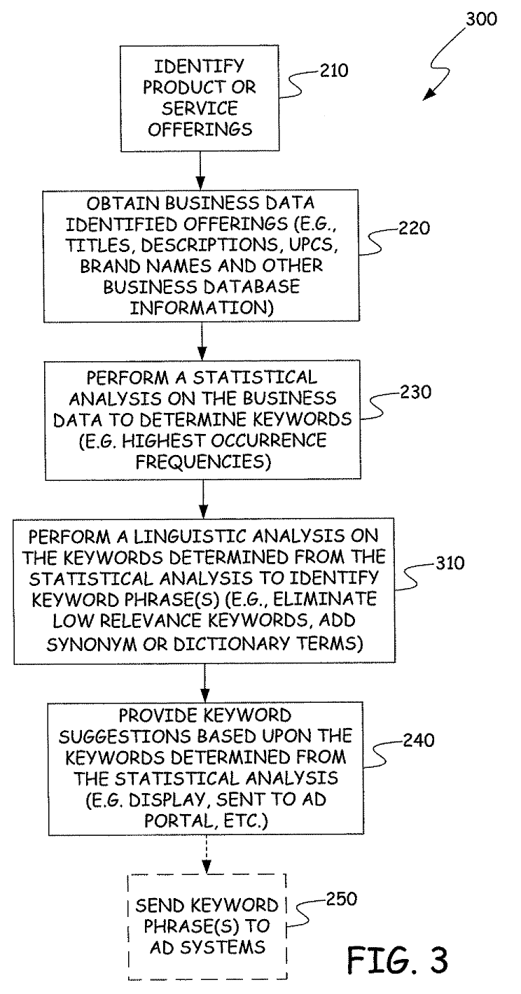

Referring to FIG. 3, shown is a flow diagram illustrating an embodiment of a method 300 which is similar to method 200, but which includes an additional step 310 before providing the keyword suggestions. In method 300, after the step 230 of performing the statistical analysis to determine keywords from the business data, a linguistic analysis is performed on the keywords determined from the statistical analysis in order to identify one or more keyword phrases as described above. Then, step 240 of providing the keyword suggestions based upon the keywords determined from the statistical analysis includes providing one or more identified keyword phrases.

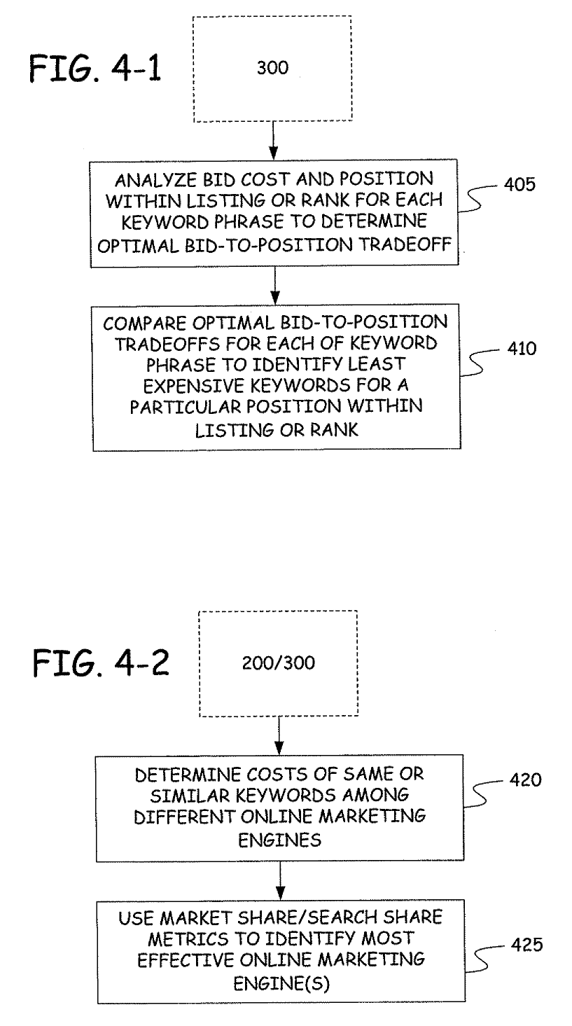

Referring now to FIG. 4-1, shown are additional steps to those shown in method 300 (FIG. 3) which can be included in some embodiments. In these embodiments, the step 240 includes providing a plurality of keyword phrases. The method shown in FIG. 4-1 then includes the step 405 of analyzing bid cost and position within listing or rank for each of the plurality of keyword phrases to determine optimal bid-to-position tradeoffs for each. Then, at step 410, the method includes comparing optimal bid-to-position tradeoffs for each of the plurality of keyword phrases to identify least expensive keywords for a particular position within listing or rank.

Referring next to FIG. 4-2, shown are additional steps to those shown in either of methods 200 (FIG. 2) or 300 (FIG. 3) which can be included in some embodiments. At step 420, the method is shown to include determining costs of same or similar keywords among different online marketing engines. Then, at step 425, these method embodiments include using market share/search share metrics to identify at least one most effective online marketing engine for the same or similar keywords.

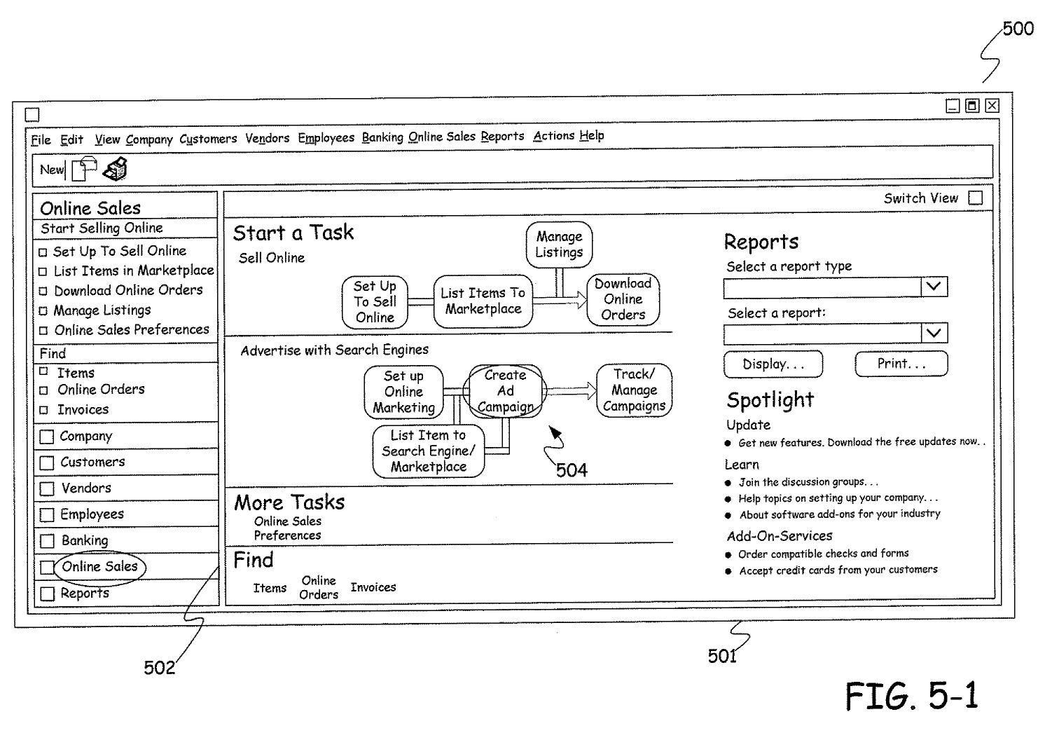

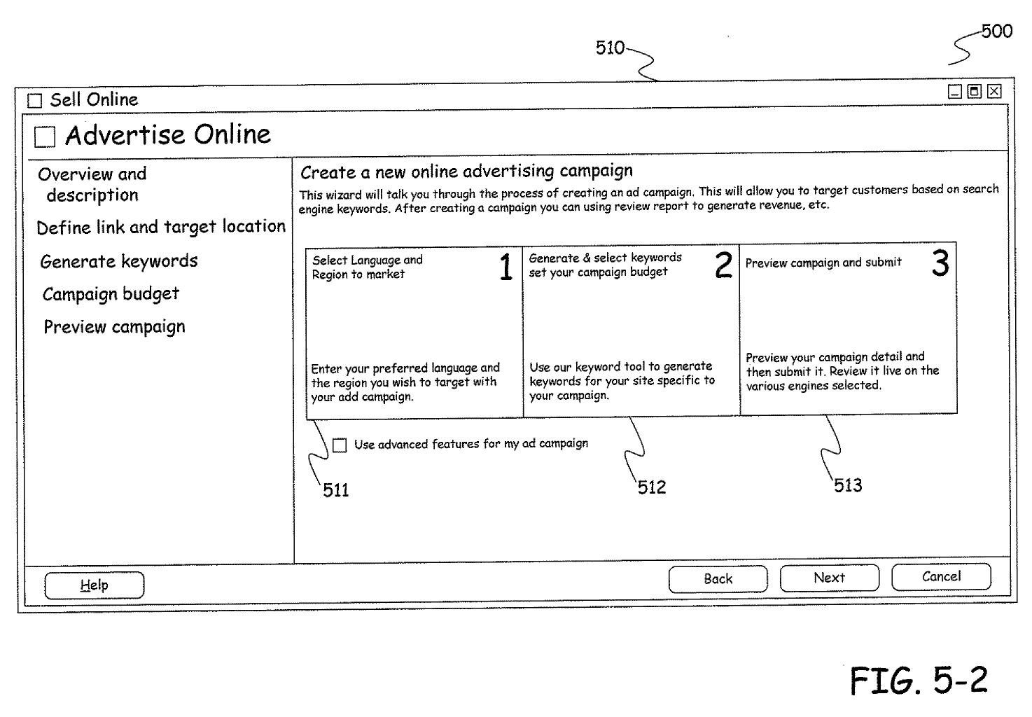

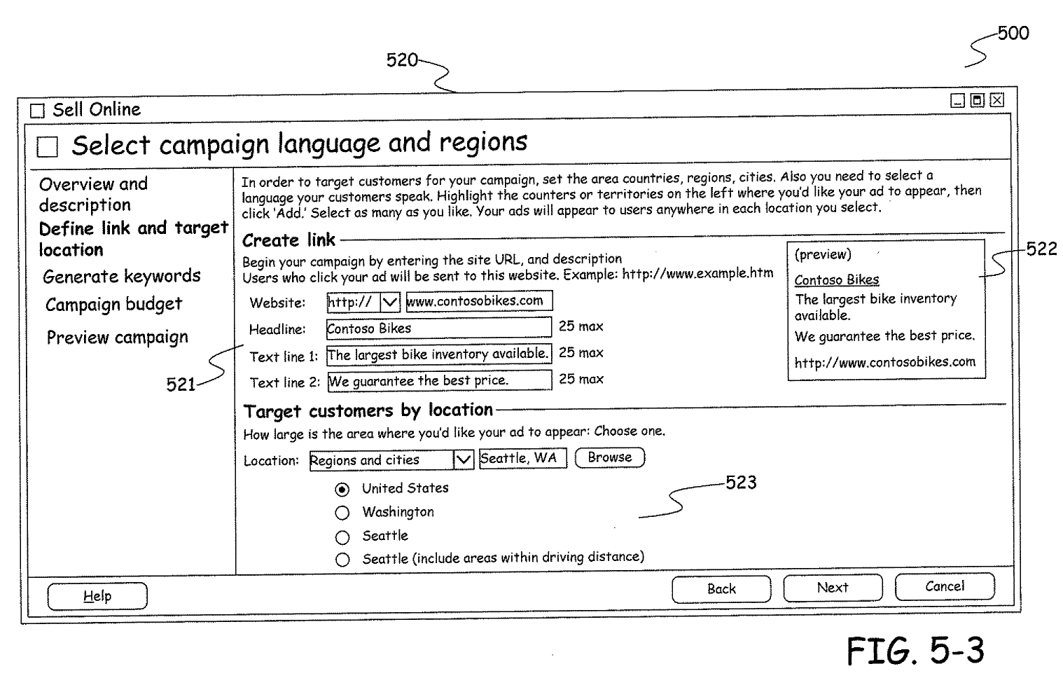

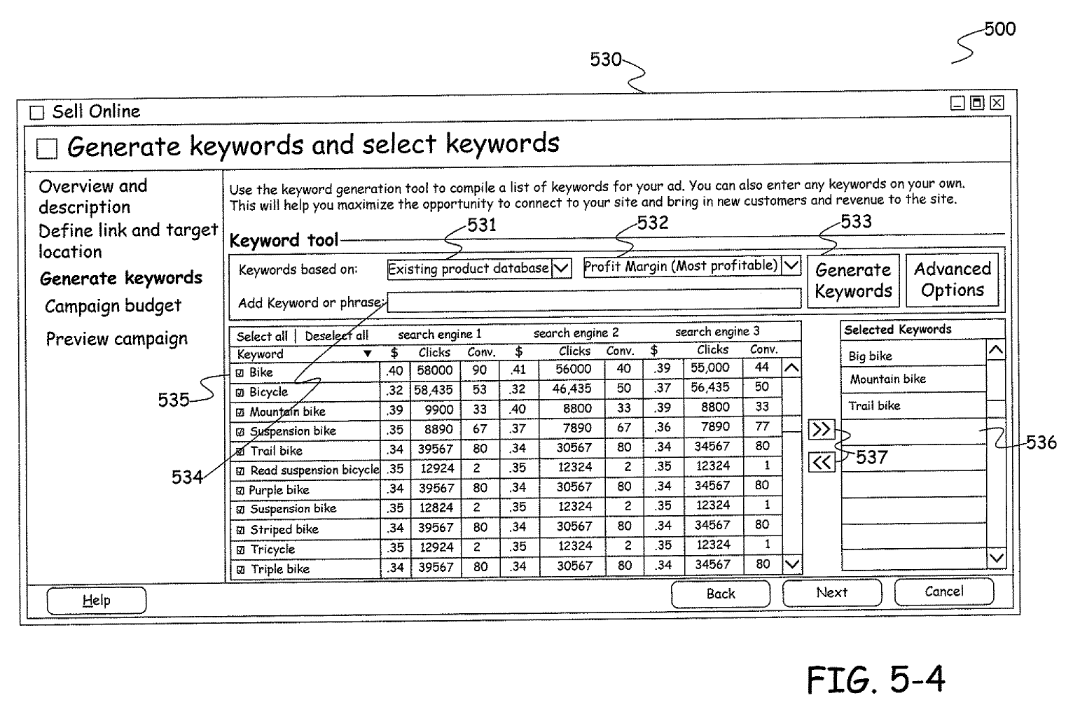

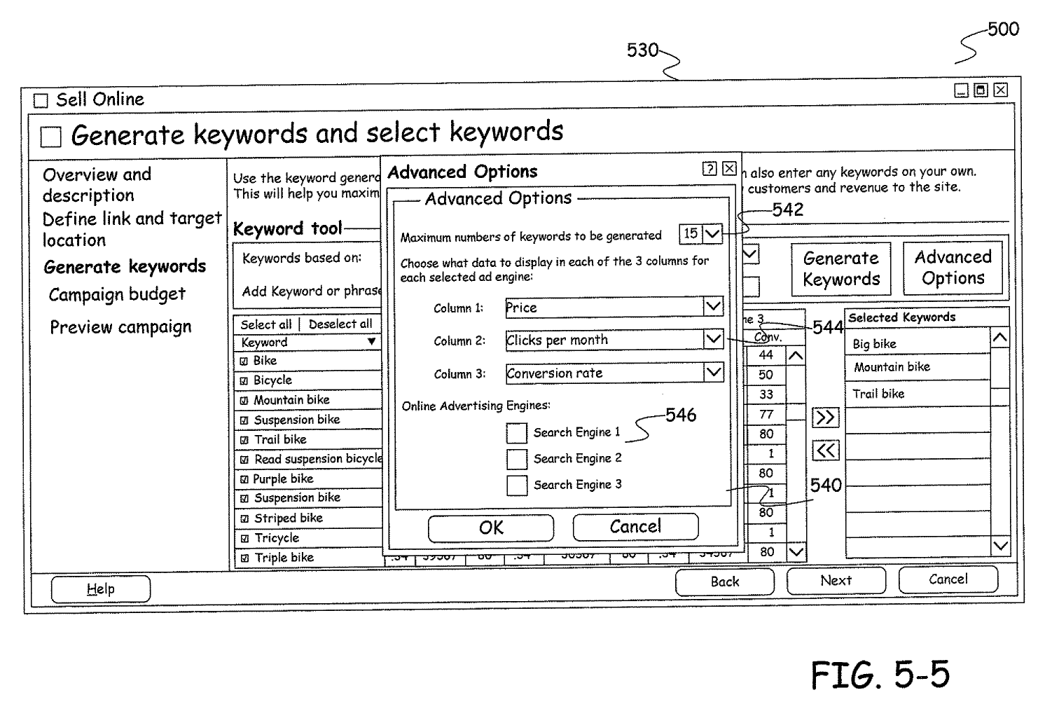

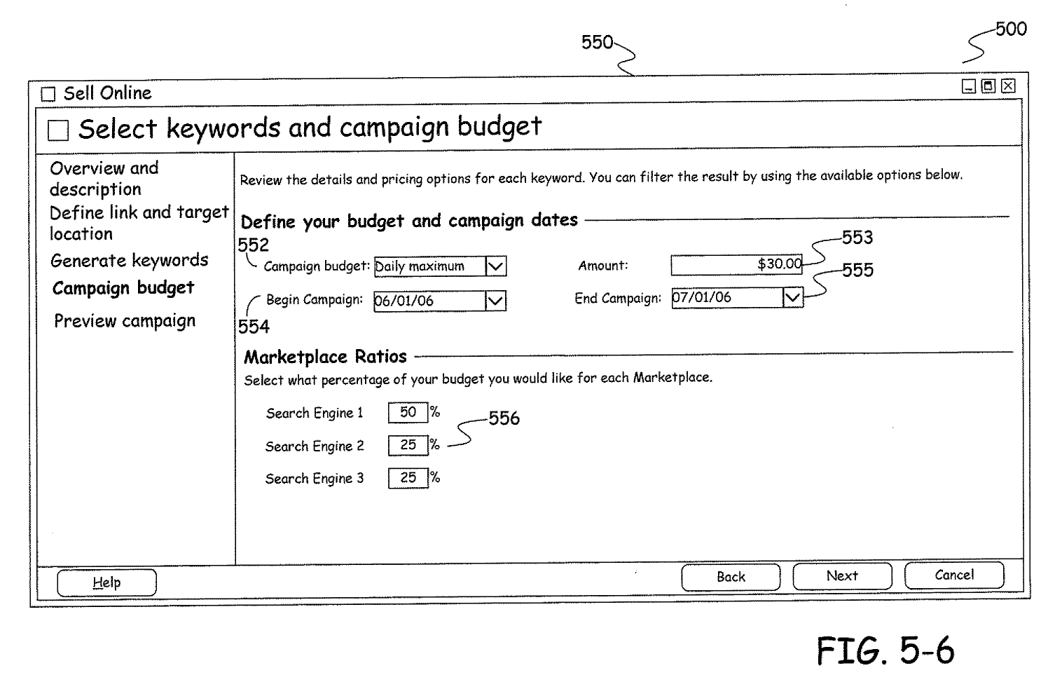

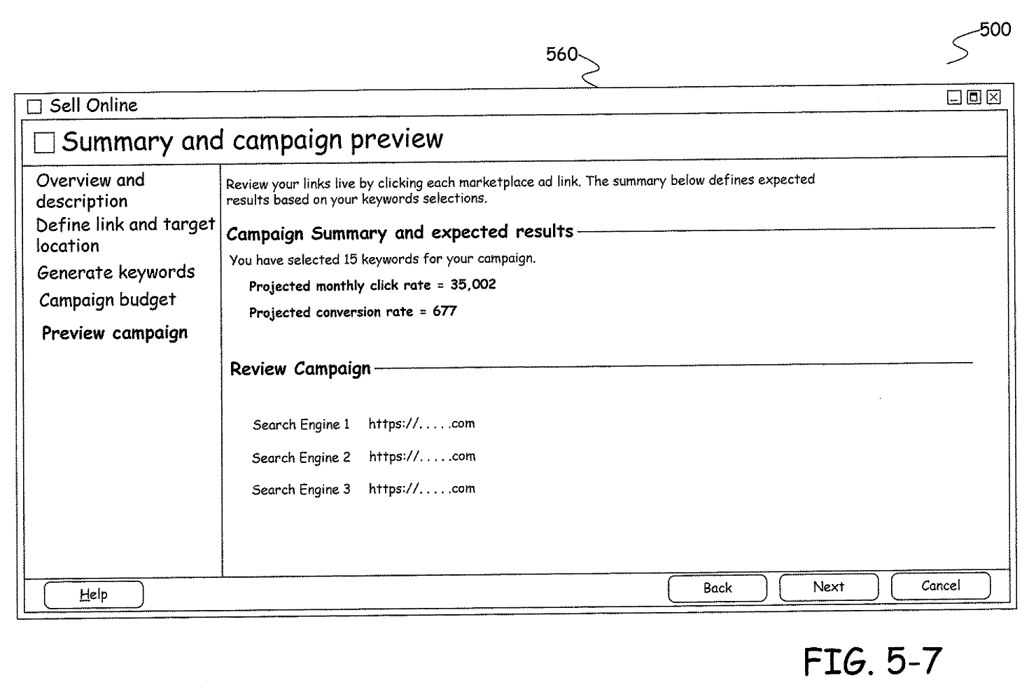

Referring now to FIGS. 5-1 through 5-7, shown are screens of a GUI 500 which can be generated by GUI component 115 for display on a display device to initiate and guide the above-described processes and functions. The particular GUI 500 shown in FIGS. 5-1 through 5-7 is provided for example purposes only, and does not limit the disclosed embodiments to use with any particular GUI, as any of a large number of GUI designs could be used with the disclosed concepts. As shown in FIG. 5-1, the GUI 500 includes a first screen 501 which presents an “Online Sales” button 502. When selected by a user, the button 502 results in the generation of buttons corresponding to different advertising functions. In one example embodiment, these buttons include a “Create Ad Campaign” button 504. Selection of button 504 results in the display of the screen of GUI 500 shown in FIG. 5-2.

FIG. 5-2 illustrates screen 510 of GUI 500 which results from the selection of button 504 on screen 501. Shown on screen 510 are a number of user selectable areas or buttons for controlling different aspects of a process of creating a new advertising campaign. For example, button 511 allows the user to select the language and region to market. Button 512 begins the particular processes of generating and selecting keywords and setting a campaign budget. Button 513 allows the user to preview the campaign and submit the keywords to the search engines (i.e., online ad systems 80) for bid or purchase. Selecting button 512 results in screen 520 shown in FIG. 5-3 being displayed.

Referring now to FIG. 5-3, shown is screen 520 of GUI 500. Screen 520 includes user inputs 521 for defining the target website address, for naming the ad or link, and for defining the text to be displayed in the ad in conjunction with the link. Using these inputs, a user creating an ad campaign can quickly set up the information for their advertisement. A preview of the ad is displayed in preview pane 522. Screen 520 also includes inputs 523 for specifying the location of customers to be targeted.

Referring now to FIG. 5-4, shown is screen 530 of GUI 500. Screen 530 is used to receive input criteria from the user for use in generating keywords, for inputting keywords directly from the user, for displaying generated keywords in conjunction with cost and click data for the keywords at several different search engines, and for selecting keywords. Shown at 531 is an input control where the user can select what source(s) of information the keywords will be based on. In the illustrated example, the keywords are to be based on an existing product database (e.g., database(s) 105). Input control 532 allows the user to select a criteria to use in generating the keyword suggestions. In the illustrated example, the criteria is to maximize profit margin (select most profitable items as basis of the ad campaign). Other example criteria which could be selected at input control 532 include reduction of highest inventory items, reduction of items which are perishable, seasonal or which have fast rates of price decay, maximization on return on investment (ROI), etc. Once these criteria are selected, button 533 can be used to generate keyword suggestions, which are illustrated in display pane 535. Other user specified keywords can also be added to the keyword list in pane 535 using input text box 534. Within display pane 535, each keyword or keyword phrase generated using the statistical analysis and linguistic analysis, as well as any user specified keywords or keyword phrases, are displayed with selected information. In this example, the selected information includes cost or price information (e.g., cost per click), with click information (e.g., total number of clicks in a given period of time or CTR based on historical search engine data), and with any other desired data such as the conversion rate. In this example, the data is displayed for each keyword or keyword phrase at each of multiple different search engines. Using input controls 537, the user can select keywords or keyword phrases from pane 535 to be added to a selected keywords list 536. The user can also remove keywords from list 536 using input controls 537.

An advanced options input button 538 is also provided on screen 530. Selection of advance options input button 538 results in an advanced options dialog box 540 being displayed as shown in FIG. 5-5. Dialog box 540 includes controls for specifying certain selectable information. For example, input 542 allows the user to select the maximum number of keywords or keyword phrases to generate. Inputs 544 are used to change the data displayed in pane 535 in conjunction with the generated keywords and keyword phrases. Inputs 546 allow the user to specify which search engines to use in generating the data to be displayed in pane 535.

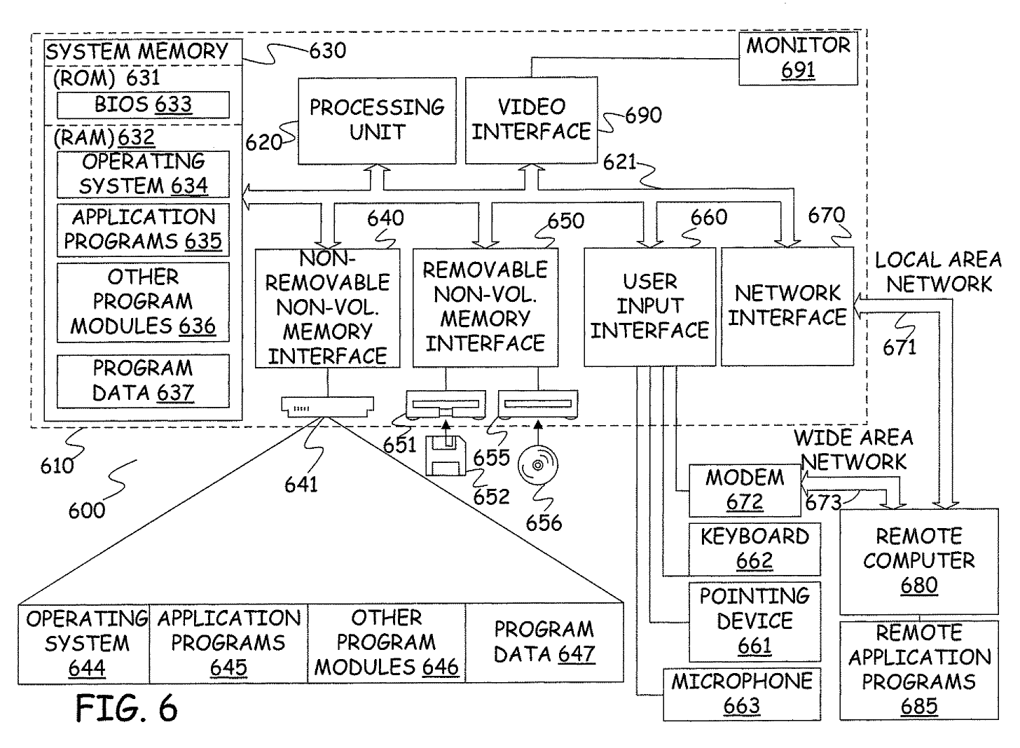

Referring now to FIG. 5-6, shown is a screen 550 of GUI 500 which allows the user to define budget parameters. For example, for selected keywords or keyword phrases, using inputs 552 and 553, the user can select a maximum budget amount for a set period of time. For instance, input 552 indicates that the budget amount of $30.00 indicated at input 553 is a daily maximum which should not be exceeded. Other time periods such as weekly maximums, monthly maximums, etc could alternatively be specified. Inputs 554 and 555 are used to select campaign begin and end dates, respectively. Finally, using inputs 556, the budget can be apportioned by percentage to multiple different search engines. Screen 560 of GUI 500, which is shown in FIG. 5-7, can then be displayed to the user to provide a summary of the campaign which has been developed. In this example, screen 560 illustrates a projected monthly click rate and a project conversion rate. Other campaign details could also, or alternatively, be displayed for summarizing.

FIG. 6 illustrates an example of a suitable computing system environment 600 on which the concepts herein described may be implemented. The computing system environment 600 is again only one example of a suitable computing environment and is not intended to suggest any limitation as to the scope of use or functionality of the description below. Neither should the computing environment 600 be interpreted as having any dependency or requirement relating to any one or combination of components illustrated in the exemplary operating environment 600.

In addition to the examples herein provided, other well known computing systems, environments, and/or configurations may be suitable for use with concepts herein described. Such systems include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The concepts herein described may be embodied in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The concepts herein described may also be practiced in distributed computing environments where tasks are performed by remote processing devices that are linked through a communications network. In a distributed computing environment, program modules may be located in both locale and remote computer storage media including memory storage devices.

With reference to FIG. 6, an exemplary system includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 600.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635 (for example email and other client programs and email server software), other program modules 636, and program data 637.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a scanner or the like. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690.

The computer 610 may operate in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a locale area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user-input interface 660, or other appropriate mechanism. In a networked environment, program modules depicted relative to the computer 610, or portions thereof may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

It should be noted that the concepts herein described can be carried out on a computer system such as that described with respect to FIG. 6, and FIG. 6 should be interpreted as being configured to carry out one or more of these various concepts. However, other suitable systems include a server, a computer devoted to message handling, or a distributed system in which different portions of the concepts are carried out on different parts of the distributed computing system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of providing keyword purchasing assistance to a business for online marketing or advertising, the method comprising:
identifying product or service offerings, of the business, to be targeted with the online marketing or advertising;
obtaining business data corresponding to the identified offerings;
performing a statistical analysis on the business data to determine keywords from the business data; and
providing keyword suggestions based upon the keywords determined from the statistical analysis.

2. The computer-implemented method of claim 1, and after the step of performing the statistical analysis to determine keywords from the business data, further comprising:
performing a linguistic analysis on the keywords determined from the statistical analysis to identify at least one keyword phrase;
wherein the step of providing the keyword suggestions based upon the keywords determined from the statistical analysis comprises providing the at least one identified keyword phrase.

3. The computer-implemented method of claim 2, wherein providing the at least one identified keyword phrase comprises displaying the at least one identified keyword phrase to a user for approval, modification or rejection.

4. The computer-implemented method of claim 2, wherein providing the at least one identified keyword phrase comprises sending the at least one identified keyword phrase to an advertising system as a step toward purchasing the at least one keyword phrase from the advertising system.

5. The computer-implemented method of claim 2, wherein obtaining the business data corresponding to the identified offerings further comprises:
obtaining, from one or more business data databases of the business, information corresponding to the identified offerings, including at least one of product or service titles, product or service descriptions, product Universal Product Codes UPCs), and product or service brand names;
wherein the step of performing the statistical analysis on the business data to determine keywords from the business data comprises performing the statistical analysis on the at least one of the product or service titles, the product or service descriptions, the product Universal Product Codes (UPCs), and the product or service brand names.

6. The computer-implemented method of claim 5, wherein the step of performing the statistical analysis on the business data to determine keywords from the business data further comprises identifying words having highest occurrence frequencies in the business data.

7. The computer-implemented method of claim 2, wherein the step of performing the linguistic analysis on the keywords determined from the statistical analysis to identify at least one keyword phrase further comprises eliminating keywords determined from the statistical analysis which have a low likelihood of being relevant to the offerings.

8. The computer-implemented method of claim 2, wherein the step of performing the linguistic analysis on the keywords determined from the statistical analysis further comprises using at least one of a synonym database and a dictionary database to identify words which are similar to the determined keywords, but more commonly used by consumers, and providing the words which are similar, to the keywords determined from the statistical analysis, in the at least one keyword phrase.

9. The computer-implemented method of claim 2, wherein providing the at least one identified keyword phrase comprises providing a plurality of keyword phrases, the method further comprising:
analyzing bid cost, bid position within sponsored listing or rank, and click through rate for each of the plurality of keyword phrases to determine optimal bid-to-position tradeoff; and
comparing optimal bid-to-position tradeoffs for each of the plurality of keyword phrases to identify least expensive keywords for a particular position within listing or rank.

10. The computer-implemented method of claim 2, and further comprising:
determining costs of same or similar keywords among different online marketing engines; and
using market share/search share metrics to identify at least one most effective online marketing engine for the same or similar keywords.

11. The computer-implemented method of claim 2, and further comprising analyzing a search tail to optimize keyword phrase purchasing cost versus click through to identify optimized keyword phrase suggestions, and providing keyword phrase suggestions based on the analysis of the search tail.

12. An online advertising campaign system for providing keyword purchasing assistance to a business for online marketing or advertising, the system comprising:
a business database containing business data corresponding to product or service offerings to be targeted with the online marketing or advertising;
a statistical analysis engine configured to perform statistical analysis on the business data to determine keywords; and
a graphical user interface component which is configured to display keyword suggestions on a display device to a user based upon the keywords determined from the statistical analysis.

13. The online advertising campaign system of claim 11, wherein the statistical analysis engine is configured to determine keywords from the business data by identifying words having highest occurrence frequencies in the business data.

14. The online advertising campaign system of claim 12, wherein the business data on which the statistical analysis engine performs the statistical analysis includes information corresponding to the identified offerings in the form of at least one of product or service titles, product or service descriptions, product Universal Product Codes UPCs), and product or service brand names.

15. The online advertising campaign system of claim 11, and further comprising a linguistic analysis engine configured to perform linguistic analysis on the keywords determined by the statistical analysis engine to identify at least one keyword phrase, the graphical user interface component displaying the at least one keyword phrase as the keyword suggestions.

16. The online advertising campaign system of claim 14, and further comprising at least one of a synonym database and a dictionary database, the linguistics analysis engine being configured to use the at least one of the synonym database and the dictionary database to identify other words which are similar to the keywords determined by the statistical analysis, and to provide the words which are similar in the at least one keyword phrase.

17. The online advertising campaign system of claim 14, and further comprising an advertising portal communication component configured to communicate with advertising portals of online advertising systems, the communication component configured to send the at least one identified keyword phrase to at least one advertising portal to purchase the at least one keyword phrase from corresponding online advertising systems.

18. The online advertising system of claim 17, and further comprising a cost analysis engine configured to communicate with the plurality of online advertising systems using the communication component, the cost analysis engine being configured to determine costs of the at least one keyword phrase at different online advertising systems and to use market share/search share metrics to identify at least one most effective online marketing engine for the keyword phrase.

19. A computer readable medium having stored thereon computer-executable instructions for implementing steps of a method of providing keyword purchasing assistance to a business for online marketing or advertising, the steps comprising:
identifying product or service offerings, of the business, to be targeted with the online marketing or advertising;
obtaining business data corresponding to the identified offerings;
performing a statistical analysis on the business data to determine keywords from the business data;
performing a linguistic analysis of the determined keywords to identify at least one keyword phrase; and
providing the at least one keyword phrase to a user as a suggestion for purchasing.

20. The computer-readable medium of claim 19, wherein the method further comprises the step of sending the at least one keyword phrase to an online advertising system to initiate purchasing of the keyword phrase.
